(19) United States
(12) Patent Application Publication
(10) Pub. No.: US 2005/0198464 A1
(43) Pub. Date: Sep. 8, 2005

(54) Lazy stack memory allocation in systems with virtual memory

(75) Inventor: Stepan Sokolov, Reading, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Savaje Technologies, Inc., Chelmsford, MA (US)

(21) Appl. No.: 11/071,868

(22) Filed: Mar. 3, 2005

Related U.S. Application Data
(60) Provisional application No. 60/550,241, filed on Mar. 4, 2004.

(51) Int. Cl. G06F 12/08

(52) U.S. Cl. 711/203; 711/170

(57) ABSTRACT

A method for mapping of logical memory regions (usually referred to as pages) of application addressable contiguous memory space to non-contiguous pages of the physical memory is provided. Each thread in an application is allocated a substantially larger amount of virtual memory, than will typically be used by the thread. Initially only the page at the top of the stack is mapped to a physical page. Later, as the stack expands, more pages of virtual memory are mapped to physical pages, up to the limit of the allocated amount. At the end opposite to the top of the stack, the page is marked as inaccessible, to allow reporting of a stack overflow condition.

### RELATED APPLICATION

This application claims the benefit of U.S. Provisional Application No. 60/550,241, filed on Mar. 4, 2004. The entire teachings of the above application are incorporated herein by reference.

### BACKGROUND OF THE INVENTION

Programs executing in a virtual memory system use virtual memory addresses. The virtual memory addresses are translated by a Memory Management Unit (MMU) to physical memory addresses that are used to access the physical memory. The virtual memory is typically much larger than the physical memory. For example, the virtual memory may be 4 Giga Bytes (GB) and the physical memory may only be 64 Kilo Bytes (KB). The MMU maps the 4 GB virtual memory address space to the 64 KB physical address space.

A multi-threaded application has multiple threads of execution which execute in parallel. Each thread is a sequential flow of control within the same application (program) and runs independently from the others, but at the same time. The thread runs within the context of the application and takes advantage of the resources allocated for the application and the application's environment. A thread must have its own resources within a running application, for example, it must have its own execution stack (portion of memory) and its own copy of the processor's registers.

Initially, a thread is typically given a fixed size execution stack (portion of virtual memory), for example, 8 KB. This stack memory size is more than sufficient for most threads and in some cases, less memory than that initially allocated would suffice. However, situations arise when 8 KB is not sufficient to carry out certain infrequent tasks, for instance, to run applications that allocate arrays or buffers as local variables. Initially, a thread is typically given a fixed size execution stack (portion of virtual memory), for example, 8 KB. This stack memory size is more than sufficient for most threads and in some cases, less memory than that initially allocated would suffice. However, situations arise when 8 KB is not sufficient to carry out certain infrequent tasks, for instance, to run applications that allocate arrays r buffers as local variables. The additional memory is allocated when needed. Thus, the execution stack memory can grow unpredictably.

Computer programs written in the JAVA programming language, typically referred to as JAVA applications typically require additional initial stack memory. JAVA is an object-oriented programming language developed by Sun Microsystems, Inc. As is well-known in the art, a JAVA application is a platform-independent program. In contrast to a native application that is compiled for a specific platform (hardware (computer and operating system)), the JAVA application can execute on any platform (hardware or software environment). The JAVA platform is a software-only platform that runs on top of other hardware-based platforms. The JAVA platform has two components: The JAVA virtual machine (JAVA VM) and the JAVA Application Programming Interface (JAVA API). JAVA source code files are compiled into an intermediate language called JAVA bytecodes (platform independent codes). Each time the program is executed, an interpreter in the JAVA Virtual Machine (VM) on the system parses and runs each JAVA bytecode instruction. The JAVA bytecodes are machine code instructions for the JAVA Virtual machine.

The JAVA VM initially allocates a small initial amount of virtual memory, for example, 16 KB for the stack in each JAVA thread and additional virtual memory is allocated to the stack when needed. By allocating a small initial amount of virtual memory, the interpreter must periodically check the current status of virtual memory, that is, if there is enough room in the stack for stack operations for example, on every procedure call. This “steals” CPU time from application execution. Also, because the virtual memory is allocated on demand, the virtual memory allocated to the stack is not contiguous. Instead, the allocated virtual memory is a linked list of blocks with a block added to the list to increase the size of the stack when needed. The blocks may even be allocated from different sections of virtual memory. Thus, the interpreter must also switch between sections of virtual memory comprising the JAVA stack.

### SUMMARY OF THE INVENTION

Frequent checks of the stack memory status are eliminated by allocating a substantially larger amount of virtual memory to the stack than will typically be used by the thread. The virtual memory is only allocated once to the thread. For example, instead of the 1 6 KB initial virtual memory allocated to a thread for a JAVA application, 64 KB of virtual memory is allocated. However, at the time of allocation only one page of the allocated virtual memory is mapped to a physical page in the system. Thus, no unnecessary physical memory is allocated to the stack.

Later, as the stack expands, more pages of the virtual memory in the stack are mapped to physical memory up to the limit of the allocated stack segment size. As the stack shrinks, mapped physical pages that are no longer being used can be efficiently returned to the system.

Also, the last allocated virtual memory page is designated to be an inaccessible page, so that if for some reason the thread reaches the end of the allocated virtual memory, a stack overflow condition is reported.

A computer implemented method for allocating memory for use as stack memory is provided. A continuous block of virtual memory is allocated for the stack memory. The size of the allocated block is substantially larger than necessary for the stack memory. A virtual page at the top of the allocated block is mapped to a first physical page of physical memory. Upon detecting an access to a next virtual page of the allocated block, the next virtual page is mapped to a second physical page of the physical memory.

The page at the bottom of the allocated block may be identified as inaccessible to allow detection of a stack overflow condition. The stack memory may be allocated for use by a thread, which may be an application thread or a kernel thread. The application thread may be for a JAVA application. In one embodiment, the allocated block of memory is 64 KB and the physical page of memory is 4 KB. The second physical page may not be contiguous with the first physical page.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a system which allocates stack memory according to the principles of the present invention;

FIG. 2 is a block diagram illustrating the organization of virtual memory space 206 and physical memory addressable space 208 in the system shown in FIG. 1;

FIG. 3 is a block diagram of a page table entry in any one of the page tables shown in FIG. 2;

FIG. 4 is a block diagram of a control block of FIG. 2;

FIG. 5 is a block diagram of a block of memory assigned to a thread with the first page mapped to a physical page;

FIG. 6 is a flow graph illustrating a method for allocating stack memory for a thread created for a JAVA application according to the principles of the present invention; and

FIG. 7 is a flow graph illustrating a method for managing the allocated stack according to the principles of the present invention.

### DETAILED DESCRIPTION OF THE INVENTION

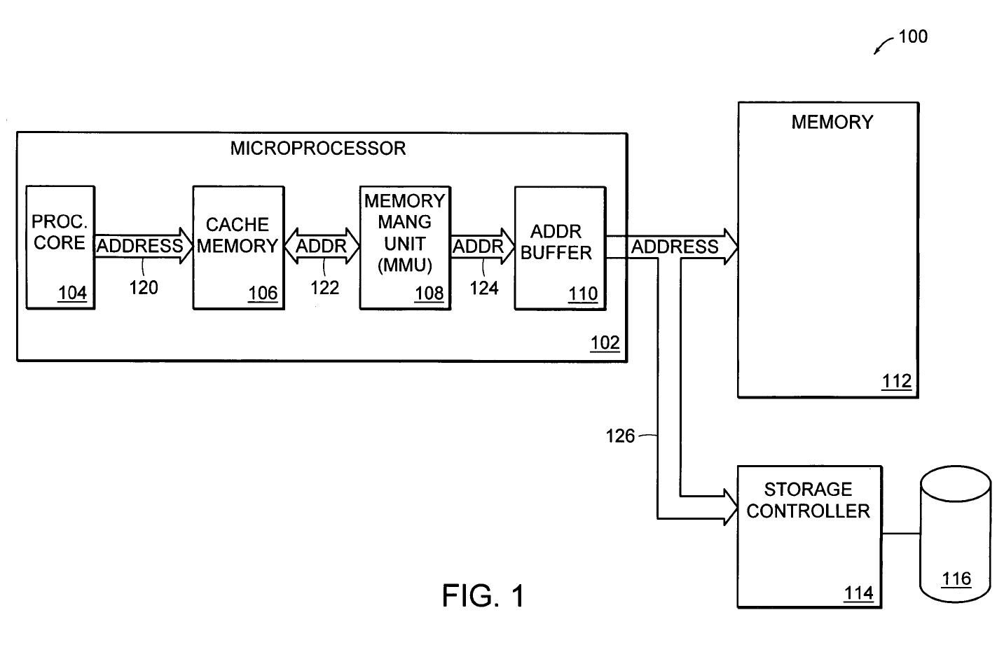

A description of preferred embodiments of the invention follows. FIG. 1 is a block diagram of a system 100 which allocates stack memory according to the principles of the present invention. The system 100 includes a microprocessor 102 and memory 112. A processor core 104 in the microprocessor 102 executes instructions which may be stored in memory 112 or cache memory 106 in the microprocessor 102. In one embodiment, the processor core 104 is an ARM processor core which executes instructions in the ARM Reduced Instruction Set (RISC). ARM is a trademark of Advanced RISC Machines, Ltd. However, the system is not limited to the ARM processor core. In other embodiments, the processor core can be Texas Instruments Incorporated's OMAP processor or a processor core available from Intel Corporation such as, the StrongARM SA-1100 processor and the XScale processor. XScale is a trademark of Intel Corporation, OMAP is a registered trademark of Texas Instruments Incorporated and StrongARM is a registered trademark of Advanced RISC Machines, Ltd.

In the embodiment shown, the processor core 104 has 32 address bits allowing it to address a 4 GB memory space. The 4 GB addressable memory space is commonly referred to as virtual memory space. The physical memory space (physical memory present in the system) includes the memory 112 and the cache memory 106. Typically the physical memory space is smaller than the virtual memory space. The microprocessor 102 includes a memory management unit (MMU) 108 which handles mapping of the virtual memory addresses (120, 122) generated by the processor core 104 to physical addresses (124, 126) for accessing the physical memory in the system.

The system includes primary storage such as memory 112 which may be semiconductor memory, for example, Random Access Memory (RAM) and secondary storage 116 which may be a disk drive or CD-ROM. The secondary storage is accessed through a storage controller 114.

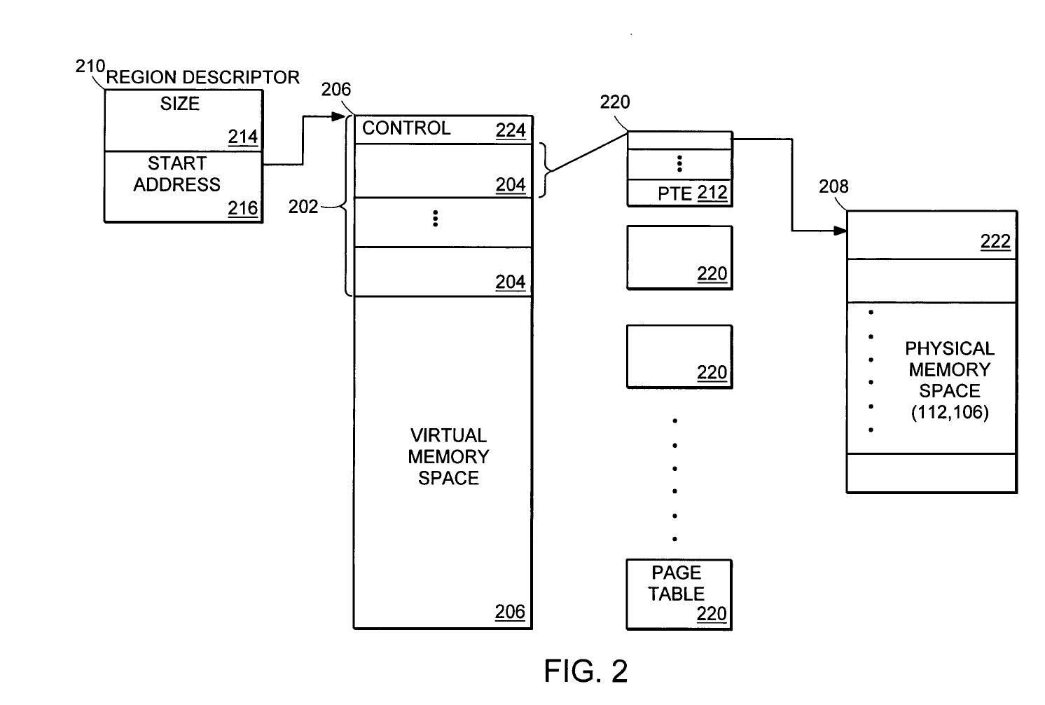

FIG. 2 is a block diagram illustrating the organization of virtual memory space 206 and physical memory space 208 in the system shown in FIG. 1. Virtual memory space 206, for example, 4 GB in the ARM architecture, is subdivided into regions 202. Each region 202 has an associated region descriptor 210 which stores the size of the subject region in a size field 214 and the start address for the region in a start address field 214.

One of the virtual memory regions 202 is allocated for use as stack memory for working threads. The stack is a region of allocated memory in which a program (application) stores status data such as procedure and function call addresses, passed parameters and sometimes local variables. As is well-known to those skilled in the art, when memory is allocated to the stack, the memory is reserved for use by the stack. The assigned virtual region 202 is logically divided into blocks 204 of the same size, each block 204 in the virtual region 202 is available to be allocated to a thread for its stack segment (native or JAVA). Each block 204 in the assigned region 202 is subdivided into pages. In the ARM architecture, a set of 4096 (4 K) bytes aligned to a 4 K byte boundary is a standard-sized page. However, larger pages (e.g., 64 K) are also permitted. In the embodiment shown, the virtual memory space 206 is 4 GB, the physical space 208 is 64 KB, each block in the virtual region is 64 KB and the page size is 4 KB. The region includes a control block 224 which is used for storing control data structures for managing the region 202. The control block 224 will be described later in conjunction with FIG. 4.

Prior to using a virtual memory address (address that a computer program uses to reference memory), the virtual memory location must be mapped to a physical address (hardware address). The hardware address is the address that corresponds to the hardware memory location in physical memory. The physical memory is the memory that is present in the system. The virtual memory address is mapped by translating the virtual memory address into a physical memory address.

A plurality of page tables 220 are used to map pages in the virtual memory space 206 to pages in physical memory space 208. Each page table 220 includes a plurality of page table entries 212. A “page table entry” (PTE) is a descriptor which identifies the mapped physical page and the access information associated with the physical page. In the ARM architecture, a “page table” has a set of 256 consecutive page table entries 212, with each page table entry having 32 bits. Multiple page tables can exist contiguously, or scattered, in memory. Each virtual page in the virtual address space 206 has an associated page table entry 212 in a page table 220. The MMU 108 interprets a PTE 212 that is associated with a virtual address and stored in the page tables 220 and uses the PTE 212 to translate the virtual memory address to the corresponding physical memory address.

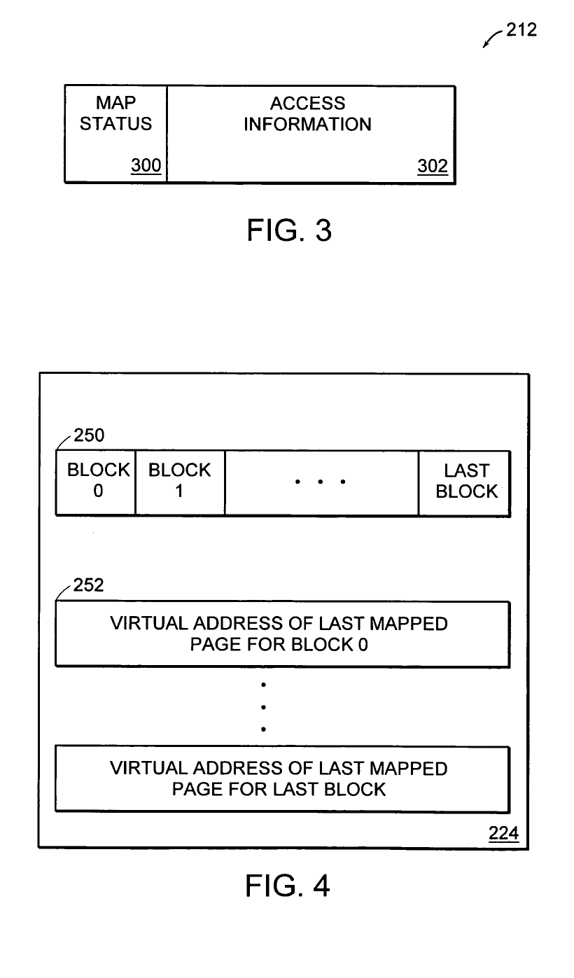

FIG. 3 is a block diagram of a PTE 212 in any one of the page tables 220 shown in FIG. 2. The PTE 212 includes a map status indicator 300 which indicates whether there is a physical page mapped to the corresponding virtual page. In the ARM architecture, bits 0 and 1 of the PTE 212 are used as the map status indicator. The page table entry also stores access information 302 for the physical page.

FIG. 4 is a block diagram of the control block 224 shown in FIG. 2. The allocation of the blocks in the assigned virtual memory region 202 to threads is controlled through a bitmap 250 which is stored in the control block 224. Each bit in the bitmap 250 corresponds to one of the blocks 204 in the region 202. To service a request to allocate a block for storing the stack for a thread, a block allocation routine stored in memory and executed by the processor core 104 first checks the state of the bits in the bitmap 250. In one embodiment, a bit set to ‘1’ in the bitmap 250 indicates that the block 204 is available. The block allocation routine searches the bitmap 250 for the first bit set to ‘1’, returns the virtual address of the block associated with the bit, and resets the bit to ‘0’ indicating that the block is being used. In one embodiment, the search begins with the bit corresponding to block ‘0’ and the virtual address is computed based on the first bit set to ‘0’, knowing that each block is the same size and the blocks are contiguous.

The control block 224 also includes a last mapped page register 252 for each block in the region. The virtual address of the last page mapped for the block 204 is stored in the last mapped page register 252 associated with the block 204. The stack operates as a Last In First Out (LIFO) memory, with the last object written to the stack being the first object read from the stack. Thus, the stack grows and shrinks dependent on the number of objects stored. A stack pointer keeps track of the last object stored in the stack. A stack pointer is a register that contains the current address of the top element of the stack.

As the stack expands, the next page in a block 204 in the region 202 allocated for the stack can be automatically mapped in response to a page fault for the block. As is well-known to those skilled in the art, a page fault occurs when software attempts to access (read or write) a virtual memory address that is not mapped to a physical memory address, that is, the unmapped page is marked “not present.” After detecting a page fault, the next page is automatically mapped by comparing the virtual address that caused the fault with the virtual address for the last mapped page stored in the last mapped page register 252 for the block 204 in the control block 224. Thus, by storing the last address of the last mapped page 252 for each block, an access to the page table 220 is avoided in order to determine whether a page in the block 204 is mapped. Also, as the stack shrinks, mapped pages that are no longer required can be easily determined by comparing the stack pointer with the address of the last page mapped for the block 204.

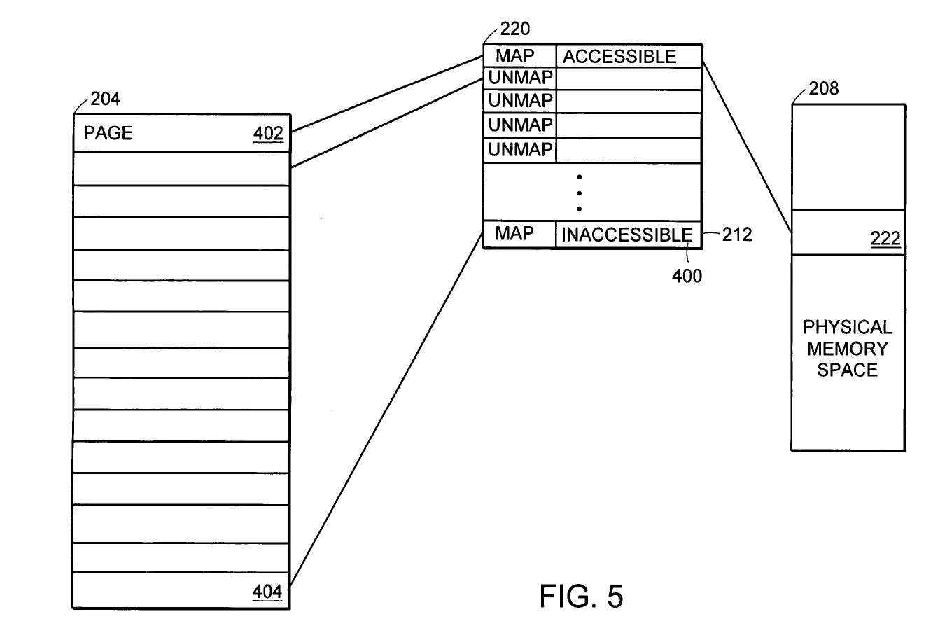

FIG. 5 is a block diagram illustrating a contiguous block of pages of virtual memory allocated to a thread, with the first page of the block mapped to a physical page. A block 204 of contiguous pages of virtual memory is initially allocated for the stack. Pages of virtual memory 402, 404 are mapped to non-contiguous pages 222 (FIG. 2) in physical memory 222 as they are required, that is, as the stack grows.

The first page 402 of the allocated block 204 is mapped to a physical page 222 in physical memory space 208 when the virtual memory block 204 is first allocated to a thread, so that the stack is immediately ready to be used without causing an initial page fault. One of the parameters of the allocation request is the direction of the stack growth (increasing or decreasing virtual addresses from the initial virtual address provided). In the embodiment shown, the stack virtual address increases from the initial virtual address provided and thus the first page 402 in the block 204 is mapped. Dependent on the direction of the stack growth, either the first 402 or the last page 404 of the block 204 is initially mapped. In addition, the page translation entry 400 corresponding to the last page 404 at the opposite end of the block 204 is marked as inaccessible. For example, the last page 404 can be marked as inaccessible in the access information field 302 in the PTE 212 associated with the page. Thus, although the last page 404 is marked as mapped in the PTE 400, the access is “inaccessible.”

In one embodiment, the first page of the block is the top of the block and the last page of the block is the bottom of the block. In an alternate embodiment, the last page of the block is the top of the block and the first page of the block is the bottom of the block.

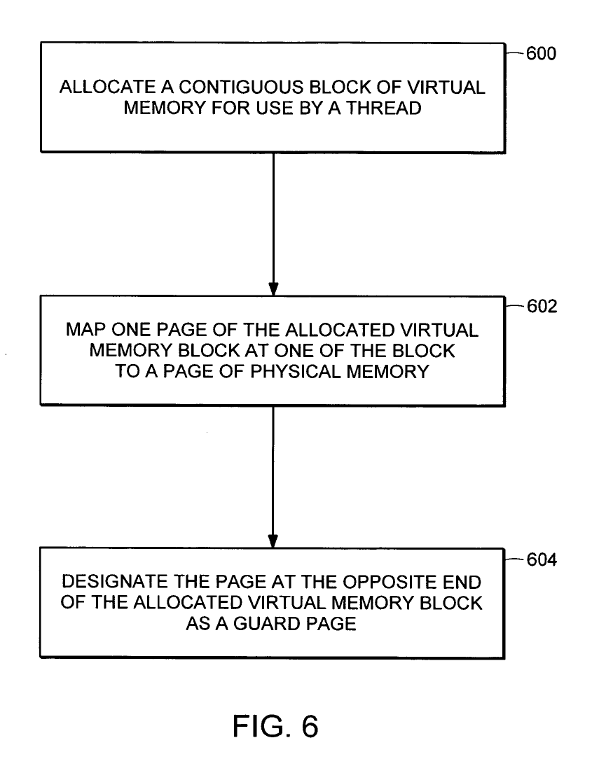

FIG. 6 is a flow graph illustrating a method for allocating stack memory for a thread created for a JAVA application according to the principles of the present invention. The flow graph is described in conjunction with the block diagram in FIG. 5.

At step 600, a thread is created for a JAVA application. As part of the initialization of the thread, a contiguous block of virtual memory 204 is allocated as stack memory for use by the thread. The allocated block 204 is substantially larger than necessary for the stack memory. In one embodiment, a typical thread uses 10-20 KB of memory and a 64 KB contiguous block of virtual memory 204 is allocated.

At step 602, dependent on the direction of growth of the stack, the page at the top of the stack (the first page 402 or last page 404) of the contiguous block of virtual memory 204 is mapped to a physical block of memory 222. In a system with 4 KB pages, only one 4 KB page (first or last) of the 64 KB block of virtual memory is mapped to physical memory. Thus, only 4 KB of the physical memory is used initially as stack memory by the thread, but the remaining 60 KB of the contiguous block of virtual memory 204 allocated to the thread, is available for use by the thread, if needed.

At step 604, the page (last or first) at the opposite end of the allocated block of virtual memory 204 to the mapped page, is marked as inaccessible, to allow reporting of a stack overflow condition. This inaccessible page is referred to as a guard page.

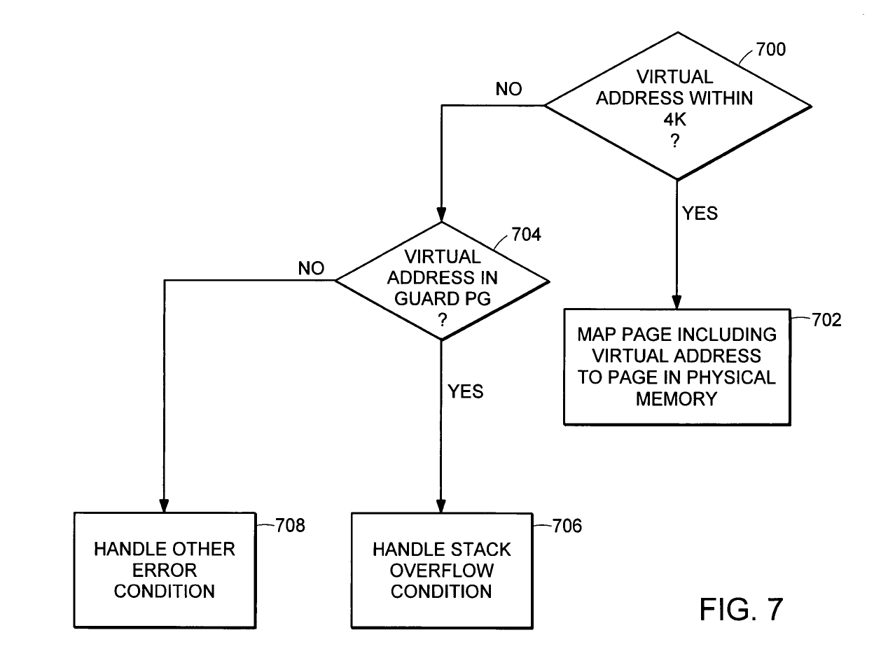

FIG. 7 is a flow graph illustrating a method for managing the allocated stack. Each time the MMU 108 (FIG. 1) receives a request to translate a virtual address that is not mapped to a physical page, an exception (processor interrupt is generated) occurs which results in a page fault exception handler being called. As is well-known to those skilled in the art, when the processor receives an interrupt, it suspends its current operation saves the status of its work and transfers control to a special routine known as an interrupt handler, which contains the instructions for dealing with the particular situation that caused the interrupt. The page fault exception handler is a set of instructions stored in memory that are executed upon detecting the page fault. A page fault occurs when software attempts to access (read or write) a virtual memory address that is not mapped to a physical memory address, that is, is “not present.” FIG. 7 is described in conjunction with FIG. 5 and FIG. 4.

At step 700, the memory page handler checks the virtual address that caused the fault. Typically, the virtual address that caused the fault is stored in one of the processor's registers.

The page fault exception handler checks that the page fault exception was due to the currently executing thread and its stack. If the virtual address that caused the page fault exception is within 4 KB of the virtual address that was last mapped to a physical address, based on the address of the last page mapped for the stack 252 stored in the control block 224, at step 702, the virtual address is related to the stack memory and another physical page 222 is automatically mapped to the next contiguous virtual page in the block 204. Control returns to the application from which the page fault exception was generated. Thus, the application is not disrupted and continues to execute as if the virtual page had been originally mapped to the physical page 222 through a PTE 212.

At step 704, if the virtual address is within the guard page 404, then at step 706 instead of mapping the virtual page to a physical page 222, a stack overflow condition is generated by the page fault exception handler, indicating that the stack for the thread has exceeded the 64 K contiguous block allocated for it. As the size of the stack allocated for each thread is restricted to the initial 64 KB allocated, a stack overflow handler is called to handle this exception condition.

At step 708, the virtual address is not within the guard page 404 or within 4 K of the last mapped page. Another handler is called to process this page fault exception condition.

As the stack shrinks, previously mapped physical pages 222 are no longer needed. Thus, these physical 222 pages can be returned to the system for use by other working threads. As the virtual address for the last mapped page for each block 204 is stored in the control region 224, it can be easily compared with the address stored in the current stack pointer. Upon detecting that the virtual address stored in the current stack pointer is less than the virtual address for the last mapped page, the last mapped page in the block 204 can be easily unmapped by modifying the associated PTE 212 in the page table.

Thus, no frequent checks of the status of the stack memory are needed. Therefore, more “CPU time” is available for other applications. Furthermore, no unnecessary physical memory is mapped and unused ranges of mapped physical memory can be efficiently returned to the system.

The invention has been described for allocating a stack for an application thread. However, the invention is not limited to application threads, the invention can also be used to allocate stack memory for a kernel (operating system) thread. As is well known in the art, a kernel is the core of an operating system, that is, the portion of the operating system that manages memory, files and peripheral devices and allocates system resources. An operating system is the software that controls the allocation and usage of hardware resources such as memory, disk space, and peripheral devices. Furthermore, the invention is not limited to allocation of memory to stacks, the invention can be used for any process or thread that requires allocation of a block of virtual memory where it is required or desired by design to gradually and undirectionally increase the utilization of such block's addresses.

It will be apparent to those of ordinary skill in the art that methods involved in the present invention may be embodied in a computer program product that includes a computer usable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

1. A computer implemented method for allocating memory for use as stack memory comprising the steps of:
allocating a contiguous block of virtual memory for the stack memory, the size of the allocated block being substantially larger than necessary for the stack memory;
mapping a virtual page at the top of the allocated block to a first physical page of physical memory; and
upon detecting an access to a next virtual page of the allocated block, mapping the next virtual page to a second physical page of the physical memory.

2. The method of claim 1, further comprising:
identifying the page at the bottom of the allocated block as inaccessible to allow detection of a stack overflow condition.

3. The method of claim 1, wherein the stack memory is allocated for use by a thread.

4. The method of claim 3, wherein the thread is an application thread.

5. The method of claim 1, wherein the allocated block of memory is 64 KB and the physical page of memory is 4 KB.

6. The method of claim 3, wherein the thread is a kernel thread.

7. The method of claim 4, wherein the application thread is for a JAVA application.

8. The method of claim 1, wherein the second physical page is not contiguous with the first physical page.

9. A computer apparatus for allocating memory for use as stack memory comprising:
a contiguous block of virtual memory allocated for stack memory and having a size substantially larger than necessary for stack memory; and
a mapping assembly for (i) mapping a virtual page at the top of the allocated block to a first physical page of physical memory and for (ii) upon detecting access to a next virtual page of the allocated block, mapping the next virtual page to a second physical page of the physical memory.

10. The apparatus of claim 9 further comprising:
an identifier for identifying the page at the bottom of the allocated block as inaccessible to allow detection of a stack overflow condition.

11. The apparatus of claim 9, wherein the stack memory is allocated for use by a thread.

12. The apparatus of claim 11, wherein the thread is an application thread.

13. The apparatus of claim 9, wherein the allocated block of memory is 64 KB and the physical page of memory is 4 KB.

14. The apparatus of claim 11, wherein the thread is a kernel thread.

15. The apparatus of claim 12, wherein the application thread is for a JAVA application.

16. The apparatus of claim 9, wherein the second physical page is not contiguous with the first physical page.

17. A computer program product for allocating memory for use as stack memory, the computer program product comprising a computer usable medium having computer readable program code thereon, including program code which:
allocates a contiguous block of virtual memory for the stack memory, the size of the allocated block being substantially larger than necessary for the stack memory;
maps a virtual page at the top of the allocated block to a first physical page of physical memory; and
upon detecting an access to a next virtual page of the allocated block, maps the next virtual page to a second physical page of the physical memory.

18. A computer apparatus for allocating memory for use as stack memory comprising:
means for allocating a contiguous block of virtual memory for the stack memory, the size of the allocated block bring substantially larger than necessary for the stack memory; and
means for mapping a virtual page at the top of the allocated block to a first physical page of physical memory and upon detecting an access to a next virtual page of the allocated block, mapping the next virtual page to a second physical page of the physical memory.
